(19) United States
(12) Patent Application Publication
(10) Pub. No.: US 2026/0186200 A1
(43) Pub. Date: Jul. 2, 2026

(54) MULTI-CORE OPTICAL DEVICE AND METHOD OF MANUFACTURING MULTI-CORE OPTICAL DEVICE

(71) Applicant: NEC Corporation, Tokyo (JP)

(72) Inventor: Yuushi MATSUO, Tokyo (JP)

(73) Assignee: NEC Corporation, Tokyo (JP)

(21) Appl. No.: 19/421,126

(22) Filed: Dec. 16, 2025

(30) Foreign Application Priority Data
Dec. 27, 2024 (JP) 2024-232323

(51) Int. Cl. G02B 6/02

(52) U.S. Cl. CPC G02B 6/02042

(57) ABSTRACT

There is provided a multi-core optical device including a first multi-core fiber including a first core and a second core, and a second multi-core fiber including a third core and a fourth core, in which the first multi-core fiber and the second multi-core fiber are connected to each other in a state in which an axis of the first core and an axis of the third core are shifted from each other, and an axis of the second core and an axis of the fourth core are shifted from each other.

### INCORPORATION BY REFERENCE

This application is based upon and claims the benefit of priority from Japanese patent application No. 2024-232323, filed on Dec. 27, 2024, the disclosure of which is incorporated herein in its entirety by reference.

### TECHNICAL FIELD

The present disclosure relates to a multi-core optical device and a method of manufacturing the multi-core optical device.

### BACKGROUND ART

JP 2015-005667 A describes that an optical loss portion is interposed between single core optical fibers connecting core portions having high gain coefficients among the core portions of two amplification multi-core fibers. As a result, since a maximum value of the core portion having a high amplification gain over the entire length is reduced, deviation of amplification gain can be further suppressed. JP 2015-005667 A discloses that the optical loss portion can be achieved by fusion-splicing single core optical fibers to be connected to each optical fiber bundle in a state in which optical axes of the single core optical fibers are shifted from each other by a predetermined amount.

### SUMMARY

However, in the technique described in JP 2015-005667 A, for example, a problem in a case where an optical attenuator is achieved by connecting two multi-core fibers to each other in a specific manner has not been studied.

In view of the above-described problems, an example object of the present disclosure is to provide an optical attenuator using two multi-core fibers.

According to a first example aspect of the present disclosure, there is provided a multi-core optical device including a first multi-core fiber including a first core and a second core, and a second multi-core fiber including a third core and a fourth core, in which the first multi-core fiber and the second multi-core fiber are connected to each other in a state in which an axis of the first core and an axis of the third core are shifted from each other, and an axis of the second core and an axis of the fourth core are shifted from each other.

According to a second example aspect of the present disclosure, there is provided a method of manufacturing a multi-core optical device, the method including connecting a first multi-core fiber including a first core and a second core to a second multi-core fiber including a third core and a fourth core in a state in which an axis of the first core and an axis of the third core are shifted from each other, and an axis of the second core and an axis of the fourth core are shifted from each other.

According to one aspect, it is possible to provide an optical attenuator using two multi-core fibers.

### BRIEF DESCRIPTION OF DRAWINGS

FIG. 1 is a diagram illustrating an example of a configuration of a multi-core optical device according to an example embodiment;

FIG. 2 is a diagram illustrating a configuration example of an optical transmission system according to the example embodiment;

FIG. 3 is a flowchart illustrating an example of a method of manufacturing the multi-core optical device according to the example embodiment;

FIG. 4 is a diagram illustrating an example of the method of manufacturing the multi-core optical device in a case where cores of MCFs according to the example embodiment are arranged to be vertically and horizontally symmetrical;

FIG. 5 is a diagram illustrating the example of the method of manufacturing the multi-core optical device in a case where the cores of the MCFs according to the example embodiment are arranged to be vertically and horizontally symmetrical;

FIG. 6 is a diagram illustrating an example of the method of manufacturing the multi-core optical device in a case where at least one of the cores of the MCFs according to the example embodiment is arranged to be vertically and horizontally asymmetric;

FIG. 7 is a diagram illustrating the example of the method of manufacturing the multi-core optical device in a case where at least one of the cores of the MCFs according to the example embodiment is arranged to be vertically and horizontally asymmetric; and

FIG. 8 is a flowchart illustrating an example of the method of manufacturing the multi-core optical device in which different types of cores according to the example embodiment are connected to each other.

### EXAMPLE EMBODIMENT

The principles of the present disclosure will be described with reference to several example embodiments. It is to be understood that the example embodiments have been described for purpose of exemplification only and will aid those skilled in the art in understanding and carrying out the present disclosure without suggesting limitations on the scope of the present disclosure. The disclosure described in the present specification is implemented in various methods other than those to be described below.

In the following description and claims, unless defined otherwise, all technical and scientific terms used in the present specification have the same meaning as commonly understood by those skilled in the art of the technical field to which the present disclosure belongs.

Hereinafter, an example embodiment of the present disclosure will be described with reference to the drawings. Each of the drawings is merely an example to illustrate one or more example embodiments. Each of the drawings is not associated with only one specific example embodiment, but may be associated with one or more other example embodiments. As those skilled in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps described in any one of the drawings may be changed as appropriate.

### First Example Embodiment

### <Configuration>

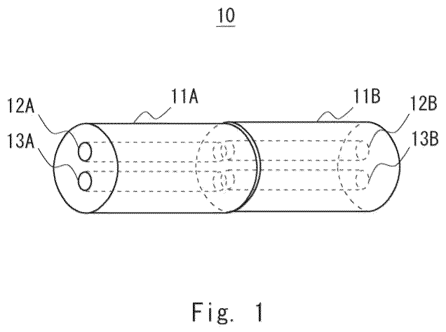

A configuration of a multi-core optical device 10 according to an example embodiment will be described with reference to FIG. 1. FIG. 1 is a diagram illustrating an example of the configuration of the multi-core optical device 10 according to the example embodiment. The multi-core optical device 10 includes a first multi-core fiber (MCF) 11A and a second multi-core fiber 11B. Hereinafter, in a case where it is not necessary to distinguish the first multi-core fiber 11A and the second multi-core fiber 11B from each other, the first multi-core fiber 11A and the second multi-core fiber 11B are also simply referred to as a “multi-core fiber 11” as appropriate.

The first multi-core fiber 11A includes a first core 12A and a second core 13A. The second multi-core fiber 11B includes a third core 12B and a fourth core 13B. In the multi-core optical device 10, the axis of the first core 12A and the axis of the third core 12B are shifted from each other, the axis of the second core 13A and the axis of the fourth core 13B are shifted from each other, and end portions of the first multi-core fiber 11A and the second multi-core fiber 11B are connected to each other. As a result, an optical attenuator of the MCF (multi-core attenuator) can be achieved. The multi-core optical device 10 of the present disclosure is fan-in/fan-out (FIFO) deviceless, and has a size similar to that of an optical attenuator of an SCF in the related art. Therefore, accommodability can be improved. As long as the number of cores of the MCF of the present disclosure is two or more, the number of cores is not limited to two.

The MCF is an optical fiber in which a plurality of cores are disposed in one clad. If the MCF is used, since separate information can be transmitted for each core, the amount of information that can be transmitted (transmission capacity) by one fiber can be increased. The FIFO is a device in which a single core fiber (SCF) is arranged according to an inter-core pitch of the MCF in order to connect the SCF and the MCF to each other.

### Second Example Embodiment

### <System Configuration>

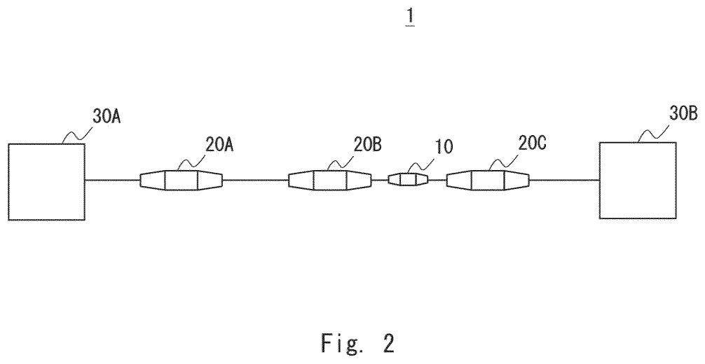

Next, a configuration of an optical transmission system 1 according to the example embodiment will be described with reference to FIG. 2. FIG. 2 is a diagram illustrating a configuration example of the optical transmission system 1 according to the example embodiment. In the example of FIG. 2, the optical transmission system 1 includes the multi-core optical device 10, optical amplification repeaters (REPs) 20A, 20B, and 20C, and communication stations 30A and 30B. Hereinafter, in a case where it is not necessary to distinguish the optical amplification repeaters 20A, 20B, and 20C from each other, the optical amplification repeaters 20A, 20B, and 20C are also simply referred to as an “optical amplification repeater 20” as appropriate. Furthermore, hereinafter, in a case where it is not necessary to distinguish the communication stations 30A and 30B from each other, the communication stations 30A and 30B are also simply referred to as a “communication station 30” as appropriate. Note that the numbers of multi-core optical devices 10, optical amplification repeaters 20, and communication stations 30 are not limited to the example of FIG. 2.

A space between the communication station 30A and the optical amplification repeater 20A, a space between the optical amplification repeater 20A and the optical amplification repeater 20B, and a space between the optical amplification repeater 20B and the multi-core optical device 10 are connected to each other in such a way that optical communication can be performed by the MCF. In addition, a space between the multi-core optical device 10 and the optical amplification repeater 20C and a space between the optical amplification repeater 20C and the communication station 30B are also connected to each other in such a way that optical communication can be performed by the MCF.

In the multi-core optical device 10, the optical attenuator of the MCF is achieved by connecting (for example, fusing or fixedly connecting by instruments) one MCF to the other MCF in a state in which axes of the MCFs are shifted from each other. The multi-core optical device 10 may be accommodated in a specific housing (Joint Box). The multi-core optical device 10 is used for various applications in the optical transmission system 1. For example, the multi-core optical device 10 may be used for line adjustment in a case where a distance between the optical amplification repeaters 20 deviates from a rated distance due to construction circumstances. Furthermore, for example, in a case where input/output intensities of various optical transmission devices (for example, a reconfigurable optical add/drop multiplexer (ROADM)) are defined by standards, the multi-core optical device 10 may be used to adjust tolerance of optical components mounted in the devices or a path length difference.

The optical amplification repeater 20 is a device that amplifies and relays an optical signal transmitted by each core of the MCF. The communication station 30 is a device that performs optical communication with another communication station 30 via the multi-core optical device 10 and the optical amplification repeater 20. In a case where communication is performed using an optical submarine cable laid on the sea floor, the communication station 30 may be referred to as, for example, a submarine cable landing station or the like. For example, the communication station 30 may convert an optical signal received from another communication station 30 into an electrical signal and relay the electrical signal to a network such as the Internet.

### <Manufacturing Method>

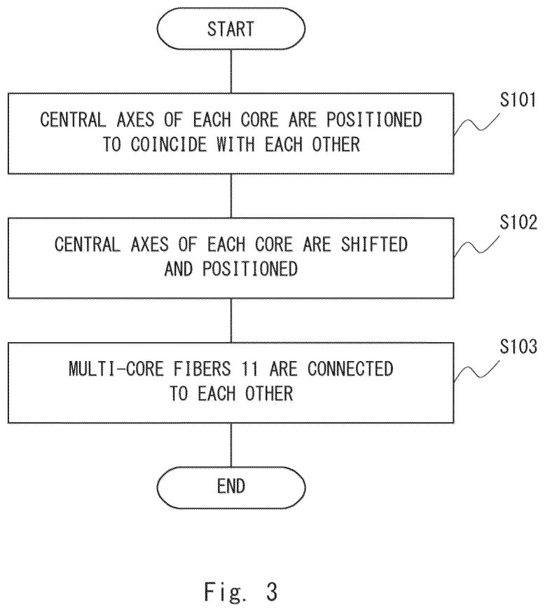

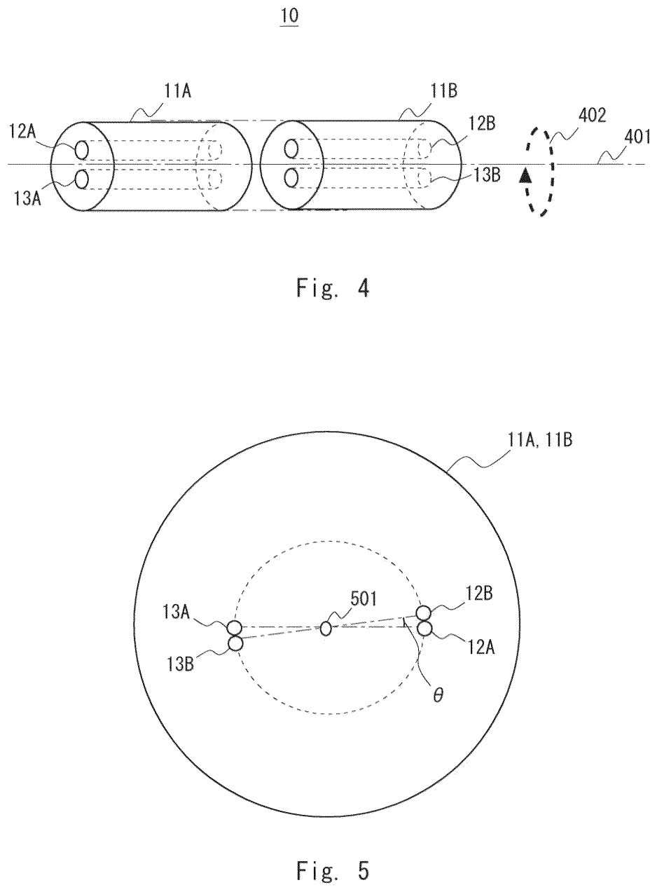

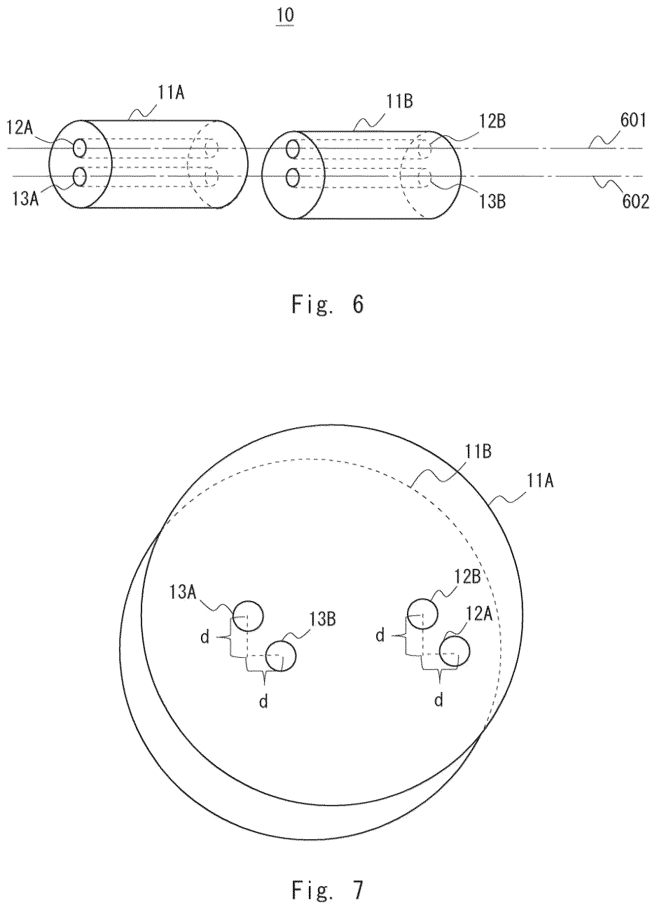

Next, an example of a method of manufacturing the multi-core optical device 10 according to the example embodiment will be described with reference to FIGS. 3 to 7. FIG. 3 is a flowchart illustrating an example of a method of manufacturing the multi-core optical device 10 according to the example embodiment. FIGS. 4 and 5 are diagrams illustrating an example of the method of manufacturing the multi-core optical device 10 in a case where the cores of the MCFs according to the example embodiment are arranged to be vertically and horizontally symmetrical. FIGS. 6 and 7 are diagrams illustrating an example of the method of manufacturing the multi-core optical device 10 in a case where at least one of the cores of the MCFs according to the example embodiment is arranged to be vertically and horizontally asymmetric.

In step S101, the multi-core fibers 11 are positioned (fixed) such that the central axes of each core of the multi-core fibers 11 coincide with each other. Here, a fusing machine that fuses the first multi-core fiber 11A with the second multi-core fiber 11B may perform alignment in such a way that the central axes of each core of the first multi-core fiber 11A and the central axes of each core of the second multi-core fiber 11B coincide with each other by image recognition or the like.

Alternatively, a position at which a transmission power of each core is maximized may be set as a position at which the central axes of each core coincide with each other while the axes are shifted from each other by using an axial shift function in a rotation direction, an axial shift function in a vertical direction, and an axial shift function in a horizontal direction by the fusing machine. In this case, for example, light having the same intensity may be input from each light source to each core of the first multi-core fiber 11A, and the light may be positioned at a position where the intensity of each light output from each core of the second multi-core fiber 11B and measured by a light intensity measuring device becomes maximum.

In addition, in a case where grooves or the like for alignment are provided in the multi-core fibers 11, the multi-core fibers 11 may be positioned in such a way that positions of the grooves in the multi-core fibers 11 are aligned by the fusing machine. As a result, the positions of the multi-core fibers 11 are aligned in such a way that the central axes of each core of the first multi-core fiber 11A and the central axes of each core of the second multi-core fiber 11B coincide with each other.

Subsequently, the central axes of each core of each multi-core fiber 11 are shifted and positioned (fixed) (step S102). A specific example of a method of shifting the central axes of each core of each multi-core fiber 11 will be described later.

Subsequently, the multi-core fibers 11 are connected to each other (step S103). Here, the first multi-core fiber 11A and the second multi-core fiber 11B may be fused with each other by the fusing machine. Hereinafter, a specific example of a method of shifting the central axes of each core of each multi-core fiber 11 will be described.

<<Case where Cores of MCFs are Arranged to be Vertically and Horizontally Symmetrical>>

In a case where the first multi-core fiber 11A and the second multi-core fiber 11B are MCFs in which each core is arranged to be vertically and horizontally symmetrical, the first multi-core fiber 11A and the second multi-core fiber 11B may be connected to each other in a state in which the axes of the first multi-core fiber 11A and the second multi-core fiber 11B are shifted from each other in a rotation axis direction (rotated). As a result, the optical attenuator of the MCF can be achieved.

FIG. 4 illustrates an example in which the first core 12A and the second core 13A of the first multi-core fiber 11A are arranged to be vertically and horizontally symmetrical, and the third core 12B and the fourth core 13B of the second multi-core fiber 11B are also arranged to be vertically and horizontally symmetrical. The first multi-core fiber 11A and the second multi-core fiber 11B are connected to each other in a state in which a central axis 401 is aligned and the axes of the first multi-core fiber 11A and the second multi-core fiber 11B are shifted in a rotation axis direction 402.

FIG. 5 illustrates an example in which the second multi-core fiber 11B is connected to the first multi-core fiber 11A by being rotated by an angle θ in the rotation direction in a case where the central axes of each multi-core fiber 11 are viewed from above. The central axis of the first multi-core fiber 11A and the central axis of the second multi-core fiber 11B are located at the same position 501. The third core 12B of the second multi-core fiber 11B is connected to the first core 12A of the first multi-core fiber 11A by being shifted from the first core 12A by an angle θ in the rotation direction. In addition, the fourth core 13B of the second multi-core fiber 11B is connected to the second core 13A of the first multi-core fiber 11A by being shifted from the second core 13A by the angle θ in the rotation direction.

In a case where the central axis of the second multi-core fiber 11B is an origin (0, 0) and coordinates of a specific core are (X, Y), the coordinates of the specific core after the second multi-core fiber 11B is rotated by θ [rad] are represented by (X cose+Y sin θ,−X sin θ+Y cos θ). Therefore, an axial shift amount (distance) d in a case where the multi-core fibers are connected while one of the multi-core fibers is shifted by the angle θ in the rotation direction is calculated by the following Formula (1).

$$d = \sqrt{{( X - ( X cos θ + Y sin θ ) )}^{2} + {( Y - ( - X sin θ + Y cos θ ) )}^{2}} \qquad ( 1 )$$

Then, a connection loss (attenuation amount) (dB) can be calculated based on the axial shift amount. A value of the connection loss in accordance with the axial shift amount may be calculated by a theoretical formula, actual measurement, or the like.

<<Case where Cores of at Least One of MCFs are not Arranged to be Vertically and Horizontally Symmetric>>

MCFs including cores that are not arranged to be vertically and horizontally symmetrical are manufactured and sold. In a case where the MCFs including the cores that are not arranged to be vertically and horizontally symmetrical are connected to each other by being shifted in the rotation direction, shift amounts of each core are different, and thus, deviation occurs in the connection loss amounts in each core.

FIG. 6 illustrates an example in which the first core 12A and the second core 13A of the first multi-core fiber 11A are arranged to be vertically and horizontally symmetrical, and the third core 12B and the fourth core 13B of the second multi-core fiber 11B are arranged to be vertically and horizontally asymmetrical. After a central axis 601 is aligned, the first core 12A and the third core 12B are connected to each other in a state in which the axes of the first core 12A and the third core 12B are shifted on a plane perpendicular to the central axis. Further, after a central axis 602 is aligned, the second core 13A and the fourth core 13B are connected to each other in a state in which the axes of the second core 13A and the fourth core 13B are shifted on the plane perpendicular to the central axis.

FIG. 7 illustrates an example in which the second multi-core fiber 11B is connected to the first multi-core fiber 11A by being shifted by a distance d in each of a longitudinal direction and a lateral direction in a case where the central axes of the multi-core fibers 11 are viewed from above. The third core 12B of the second multi-core fiber 11B is connected to the first core 12A of the first multi-core fiber 11A by being shifted from the first core 12A by a distance (d²+d²)^{1/2}. In addition, the fourth core 13B of the second multi-core fiber 11B is connected to the second core 13A of the first multi-core fiber 11A by being shifted from the second core 13A by the distance (d²+d²)^{1/2}.

In a case where at least one of the first multi-core fiber 11A and the second multi-core fiber 11B is the MCF including the cores that are not arranged to be vertically and horizontally symmetric, the multi-core fibers 11A and 11B may be connected to each other in a state in which the axes of the first multi-core fiber 11A and the second multi-core fiber 11B are shifted on the plane perpendicular to the central axis of each multi-core fiber 11. In this case, for example, one multi-core fiber 11 may be moved on the plane perpendicular to the central axis of each multi-core fiber 11 to be connected to the other multi-core fiber 11. More specifically, the first multi-core fiber 11A and the second multi-core fiber 11B may be connected to each other by the following procedures. As a result, the shift amounts of each core can be made the same.

### Example of Positioning by Fusing Machine

For example, the fusing machine that fuses the first multi-core fiber 11A with the second multi-core fiber 11B may align the positions of each core of the first multi-core fiber 11A and the positions of each core of the second multi-core fiber 11B by image recognition or the like. Then, according to the following procedures, for example, a decrease in a connection area between the first multi-core fiber 11A and the second multi-core fiber 11B can be further reduced in such a way as to make fusion easier.

For example, the fusing machine may hold the first multi-core fiber 11A and the second multi-core fiber 11B at positions where the cores are connected to each other side by side in the lateral direction (hereinafter, also referred to as the “horizontal direction” as appropriate) or a longitudinal direction (hereinafter, also referred to as the “vertical direction” as appropriate) on the plane perpendicular to the central axis of each multi-core fiber 11. Then, as illustrated in FIG. 7, the fusing machine may shift the second multi-core fiber 11B by the same amount (for example, the distance d) in the longitudinal direction and the lateral direction on the plane perpendicular to the central axis of each multi-core fiber 11, and then fuse the first multi-core fiber 11A with the second multi-core fiber 11B.

Alternatively, the fusing machine may hold the first multi-core fiber 11A and the second multi-core fiber 11B in such a way that, after the cores are aligned with each other, the cores are arranged on a straight line of 45 degrees on the plane perpendicular to the central axis of each multi-core fiber 11. Then, the fusing machine may shift the second multi-core fiber 11B in the vertical direction or the horizontal direction and then fuse the first multi-core fiber 11A with the second multi-core fiber 11B.

### Example of Positioning by Power Monitor

The axes of each multi-core fiber 11 may be shifted in at least one of the lateral direction on the plane perpendicular to the central axis of each multi-core fiber 11, the longitudinal direction on the plane perpendicular to the central axis, and the rotation axis direction, and then the multi-core fibers 11 may be connected to each other at positions where the transmission powers of the cores are equal to each other. In this case, for example, the first multi-core fiber 11A and the second multi-core fiber 11B may be fused with each other at the position where the transmission powers of the cores are equal to each other while the axes are shifted from each other by using at least one of the axial shift function in the rotation direction, the axial shift function in the vertical direction, and the axial shift function in the horizontal direction by the fusing machine. In this case, for example, light having the same intensity may be input from each light source to each core of the first multi-core fiber 11A, and the light may be fused at a position where the intensity of each light output from each core of the second multi-core fiber 11B and measured by the light intensity measuring device becomes the same.

### Example of Achieving Optical Attenuator Having Inter-Core Deviation

In the above-described example, a description has been given as to an example in which the multi-core optical device 10 does not have inter-core deviation (an attenuation amount due to a connection portion between two cores is the same in each multi-core). Hereinafter, a description will be given as to an example in which the multi-core optical device 10 has inter-core deviation (an attenuation amount due to a connection portion between two cores is different in each multi-core). In the following description, each core of each MCF may be arranged to be vertically and horizontally symmetric or may not be arranged to be vertically and horizontally symmetric.

In the optical transmission system 1, for example, an uplink path and a downlink path are configured by one MCF, and a difference in path length may occur between an uplink direction (for example, from the communication station 30A to the communication station 30B) and a downlink direction (for example, from the communication station 30B to the communication station 30A). For example, there is a case in which a specific core is bypassed by a FIFO, a branching device (a branching unit or a switch), or the like and then is connected to the same MCF as another core. In this case, it is conceivable that an optical attenuator having different attenuation amounts between cores is required.

In addition, even in a case where the input/output intensity of the transmission device is defined by standards and it is necessary to adjust tolerance of the optical components mounted in the device or a path length difference, it is considered that the optical attenuator having different attenuation amounts between the cores is required. In addition, even in a case where there is a difference in attenuation amount between the cores of the MCF and it is necessary to adjust the path length difference, it is conceivable that the optical attenuator having different attenuation amounts between the cores is required.

### Example of Positioning by Fusing Machine

For example, the fusing machine that fuses the first multi-core fiber 11A with the second multi-core fiber 11B may align the positions of each core of the first multi-core fiber 11A and the positions of each core of the second multi-core fiber 11B by image recognition or the like. Then, the axes may be shifted from each other by a specific amount in at least one of the rotation direction, the vertical direction, and the horizontal direction using the axial shift function in the rotation direction, the axial shift function in the vertical direction, and the axial shift function in the horizontal direction by the fusing machine.

Coordinates C1 and C2 of each core before shifting the axes are defined as C1=(s, t) and C2=(u, v). In a case where coordinates after shifting the axes are defined by C1′=(s′, t′) and C2′=(u′, v′), a shift amount in an X-axis direction is defined by x [um], a shift amount in a Y-axis direction is defined by y [um], and a shift angle in a θ-axis direction (rotation direction) is defined by θ [rad], s′, t′, u′, and v′ are expressed as follows.

$$The coordinates of C {1}^{′} : {s}^{′} = ( s + x ) cos θ + ( t + y ) sin θ , {t}^{′} = - ( s + x ) sin θ + ( t + y ) cos θ$$

$$The coordinates of C {2}^{′} : {u}^{′} = ( u + x ) cos θ + ( v + y ) sin θ , {v}^{′} = - ( u + x ) sin θ + ( v + y ) cos θ$$

At this time, an axial shift amount d1 of C1 and an axial shift amount d2 of C2 can be calculated as follows.

$$\begin{matrix}d 1 = \sqrt{{( s - {s}^{′} )}^{2} + {( t - {t}^{′} )}^{2}} , \\ d 2 = \sqrt{{( u - {u}^{′} )}^{2} + {( v - {v}^{′} )}^{2}}\end{matrix}$$

Therefore, it is possible to calculate an axial shift amount of each core by determining core arrangement information of the MCF and the axial shift amount in the axes.

### Example of Positioning by Power Monitor

The first multi-core fiber 11A and the second multi-core fiber 11B may be fused with each other at the position where the transmission powers of the cores have different specific values while the axes are shifted from each other by using the axial shift function in the rotation direction, the axial shift function in the vertical direction, and the axial shift function in the horizontal direction by the fusing machine. In this case, for example, light having the same intensity may be input from each light source to each core of the first multi-core fiber 11A, and the light may be fused at the position where the intensity of each light output from each core of the second multi-core fiber 11B and measured by the light intensity measuring device has a different specific value.

### Example in Which Cores Have Different Characteristics

In order to reduce crosstalk and the like, MCFs having different characteristics such as loss in each core are manufactured and sold. In a case where such MCFs are used, it is considered that it is required to adjust an attenuation amount and an amount of crosstalk in each path (for example, a path from the communication station 30A to the communication station 30B and a path from the communication station 30B to the communication station 30A) of each core to be a similar value by connecting different types of cores of the MCFs to each other.

In this case, the second multi-core fiber 11B is rotated by an angle in accordance with the number of cores of the first multi-core fiber 11A and the second multi-core fiber 11B, and then is connected to the first multi-core fiber 11A as in each example described above. More specifically, in a case where the number of cores of each multi-core fiber 11 is n (n is an integer of 2 or more), the second multi-core fiber 11B may be rotated by 360/n degrees. Then, the first multi-core fiber 11A and the second multi-core fiber 11B may be connected to each other by any one of the above-described methods including “a case where cores of MCFs are arranged to be vertically and horizontally symmetric”, “a case where cores of at least one of MCFs are not arranged to be vertically and horizontally symmetric”, and “example of achieving optical attenuator having inter-core deviation”.

In this case, the first core 12A of the first multi-core fiber 11A has a first characteristic, and the second core 13A has a second characteristic different from the first characteristic. In addition, the third core 12B of the second multi-core fiber 11B has the second characteristic, and the fourth core 13B has the first characteristic. Then, the axis of the first core 12A and the axis of the third core 12B are shifted from each other, the axis of the second core 13A and the axis of the fourth core 13B are shifted from each other, and the first multi-core fiber 11A and the second multi-core fiber 11B are connected to each other.

### <Manufacturing Method>

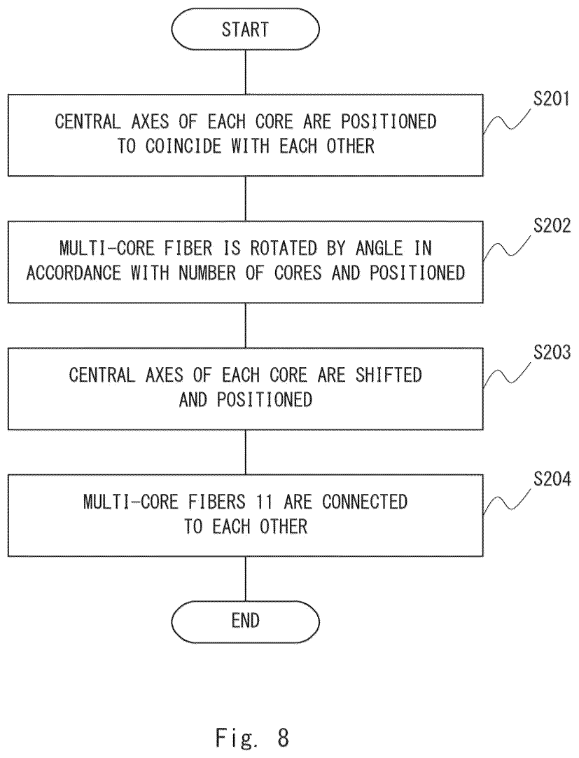

Next, an example of a method of manufacturing the multi-core optical device 10 in which different types of cores according to the example embodiment are connected to each other will be described with reference to FIG. 8. FIG. 8 is a flowchart illustrating an example of a method of manufacturing the multi-core optical device 10 in which different types of cores according to the example embodiment are connected to each other.

In step S201, the multi-core fibers 11 are positioned (fixed) such that the central axes of each core of each multi-core fiber 11 coincide with each other. The processing may be similar to the processing in step S101 in FIG. 3.

Subsequently, one of the multi-core fibers 11 (for example, the second multi-core fiber 11B) is rotated by an angle in accordance with the number of cores and positioned (step S202).

Subsequently, the central axes of each core of each multi-core fiber 11 are shifted and positioned (fixed) (step S203). The processing may be similar to the processing in step S102 in FIG. 3.

Subsequently, the multi-core fibers 11 are connected to each other (step S204). The processing may be similar to the processing in step S103 in FIG. 3.

### Example of Achieving Turning Connection Point

In laying a submarine cable, there is a limit to a length of cables that can be carried on the ship. Therefore, in the case of a long-distance system, a laying work is executed a plurality of times. In this case, monitoring of a state of an optical line of a previously laid cable may be required until all cables are laid. Here, a turning connection point at which tips of two MCFs laid in parallel are mutually connected to each other is generated. Then, an optical signal transmitted from the communication station 30A is transmitted through one MCF, is turned back at the turning connection point, is transmitted through the other MCF, and is received by the communication station 30A. As a result, it is possible to remotely monitor whether there is an abnormality in the two MCFs. Then, after laying of the MCFs from both directions is completed, the sunk turning connection point is pulled up, and the MCF from the communication station 30A and the MCF from the communication station 30B are connected to each other.

In a case where the MCFs are turned back and connected to each other after conversion into the SCF in the FIFO manner, a housing space of a housing at the turning point is compressed. On the other hand, according to the technique of the present disclosure, the FIFO is unnecessary, and thus, it is possible to reduce the size.

In an MCF system, in order to suppress inter-core crosstalk, a method in which opposing transmission is performed in adjacent cores is often adopted. In this case, the first core 12A of the first multi-core fiber 11A and the fourth core 13B of the second multi-core fiber 11B are used for uplink transfer (transmission), and the second core 13A of the first multi-core fiber 11A and the third core 12B of the second multi-core fiber 11B are used for downlink transfer (reception). In this case, similarly to the above-described “example in which cores have different characteristics”, the first core 12A of the first multi-core fiber 11A for transmission and the third core 12B of the second multi-core fiber 11B for reception are connected to each other, and the fourth core 13B of the second multi-core fiber 11B for transmission and the second core 13A of the first multi-core fiber 11A for reception are connected to each other.

### <Others>

In response to a recent increase in demand for communication capacity, a multi-core technique in an optical transmission system has attracted attention. Although multi-core transmission fibers are being developed, existing single-core (single-mode) optical devices are also used. In this case, it is necessary to connect an SCF to each core of an MCF using a FIFO and to connect each SCF to another MCF using the FIFO again.

Therefore, the number of required optical devices is increased as compared with a single-core system of the related art. Therefore, for example, in a case where a housing space of a housing for housing optical devices is limited, it is required to simplify or downsize the optical devices. According to the present disclosure, it is possible to provide an optical attenuator in which two multi-core fibers are connected to each other in a specific manner. Therefore, a size of the optical attenuator can be reduced as compared with a case of using the FIFO.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Some or all of the above example embodiments may be described as the following Supplementary Notes, but are not limited to the following Supplementary Notes. Some or all of the elements (for example, configurations and functions) described in each Supplementary Note dependent on Supplementary Note 1 can also be dependent on an independent Supplementary Note of another category in a similar dependency relationship. Some or all of the elements described in any Supplementary Note may be applied to various types of hardware, software, recording means for recording software, systems, and methods.

### (Supplementary Note 1)

A multi-core optical device including:
a first multi-core fiber including a first core and a second core; and
a second multi-core fiber including a third core and a fourth core,
in which the first multi-core fiber and the second multi-core fiber are connected to each other in a state in which an axis of the first core and an axis of the third core are shifted from each other, and an axis of the second core and an axis of the fourth core are shifted from each other.

### (Supplementary Note 2)

The multi-core optical device according to Supplementary Note 1, in which
the first core and the second core are arranged to be vertically and horizontally symmetrical in the first multi-core fiber,
the third core and the fourth core are arranged to be vertically and horizontally symmetrical in the second multi-core fiber, and
the first multi-core fiber and the second multi-core fiber are connected to each other in a state in which axes are shifted from each other in a rotation axis direction.

### (Supplementary Note 3)

The multi-core optical device according to Supplementary Note 1, in which
the first core and the second core are arranged to be vertically and horizontally asymmetrical in the first multi-core fiber, and
the first multi-core fiber and the second multi-core fiber are connected to each other in a state in which axes are shifted from each other on a plane perpendicular to a central axis.

### (Supplementary Note 4)

The multi-core optical device according to Supplementary Note 3, in which the first multi-core fiber and the second multi-core fiber are connected to each other by shifting the second multi-core fiber by the same amount in a longitudinal direction and a lateral direction on the plane perpendicular to the central axis from a position at which the cores are connected side by side in the lateral direction or the longitudinal direction on the plane perpendicular to the central axis.

### (Supplementary Note 5)

The multi-core optical device according to Supplementary Note 3, in which the first multi-core fiber and the second multi-core fiber are connected to each other by shifting the second multi-core fiber in a longitudinal direction or a lateral direction on the plane perpendicular to the central axis from a position at which the cores are connected side by side on a straight line of 45 degrees on the plane perpendicular to the central axis.

### (Supplementary Note 6)

The multi-core optical device according to Supplementary Note 3, in which the axes of the first multi-core fiber and the second multi-core fiber are shifted in at least one of a lateral direction on the plane perpendicular to the central axis, a longitudinal direction on the plane perpendicular to the central axis, and a rotation axis direction, and the first multi-core fiber and the second multi-core fiber are connected to each other at a position where transmission powers of the cores are equal to each other.

### (Supplementary Note 7)

The multi-core optical device according to Supplementary Note 1, in which the axis of the first core and the axis of the third core are shifted from each other and the axis of the second core and the axis of the fourth core are shifted from each other in such a way that an attenuation amount of a connection portion between the first core and the third core is different from an attenuation amount of a connection portion between the second core and the fourth core, and the first multi-core fiber and the second multi-core fiber are connected to each other.

### (Supplementary Note 8)

The multi-core optical device according to Supplementary Note 1, in which
the first core and the fourth core each have a first characteristic, and the second core and the third core each have a second characteristic different from the first characteristic.

### (Supplementary Note 9)

The multi-core optical device according to Supplementary Note 1, in which the first core and the fourth core are cores for transmission, the second core and the third core are cores for reception, and the first to fourth cores form a turning connection point.

### (Supplementary Note 10)

A method of manufacturing a multi-core optical device, the method including connecting a first multi-core fiber including a first core and a second core to a second multi-core fiber including a third core and a fourth core in a state in which an axis of the first core and an axis of the third core are shifted from each other, and an axis of the second core and an axis of the fourth core are shifted from each other.

1. A multi-core optical device comprising:
a first multi-core fiber including a first core and a second core; and
a second multi-core fiber including a third core and a fourth core,
wherein the first multi-core fiber and the second multi-core fiber are connected to each other in a state in which an axis of the first core and an axis of the third core are shifted from each other, and an axis of the second core and an axis of the fourth core are shifted from each other.

2. The multi-core optical device according to claim 1, wherein
the first core and the second core are arranged to be vertically and horizontally symmetrical in the first multi-core fiber,
the third core and the fourth core are arranged to be vertically and horizontally symmetrical in the second multi-core fiber, and
the first multi-core fiber and the second multi-core fiber are connected to each other in a state in which axes are shifted from each other in a rotation axis direction.

3. The multi-core optical device according to claim 1, wherein
the first core and the second core are arranged to be vertically and horizontally asymmetrical in the first multi-core fiber, and
the first multi-core fiber and the second multi-core fiber are connected to each other in a state in which axes are shifted from each other on a plane perpendicular to a central axis.

4. The multi-core optical device according to claim 3, wherein the first multi-core fiber and the second multi-core fiber are connected to each other by shifting the second multi-core fiber by the same amount in a longitudinal direction and a lateral direction on the plane perpendicular to the central axis from a position at which the cores are connected side by side in the lateral direction or the longitudinal direction on the plane perpendicular to the central axis.

5. The multi-core optical device according to claim 3, wherein the first multi-core fiber and the second multi-core fiber are connected to each other by shifting the second multi-core fiber in a longitudinal direction or a lateral direction on the plane perpendicular to the central axis from a position at which the cores are connected side by side on a straight line of 45 degrees on the plane perpendicular to the central axis.

6. The multi-core optical device according to claim 3, wherein the axes of the first multi-core fiber and the second multi-core fiber are shifted in at least one of a lateral direction on the plane perpendicular to the central axis, a longitudinal direction on the plane perpendicular to the central axis, and a rotation axis direction, and the first multi-core fiber and the second multi-core fiber are connected to each other at a position where transmission powers of the cores are equal to each other.

7. The multi-core optical device according to claim 1, wherein the axis of the first core and the axis of the third core are shifted from each other and the axis of the second core and the axis of the fourth core are shifted from each other in such a way that an attenuation amount of a connection portion between the first core and the third core is different from an attenuation amount of a connection portion between the second core and the fourth core, and the first multi-core fiber and the second multi-core fiber are connected to each other.

8. The multi-core optical device according to claim 1, wherein
the first core and the fourth core each have a first characteristic, and
the second core and the third core each have a second characteristic different from the first characteristic.

9. The multi-core optical device according to claim 1, wherein the first core and the fourth core are cores for transmission, the second core and the third core are cores for reception, and the first to fourth cores form a turning connection point.

10. A method of manufacturing a multi-core optical device, the method comprising connecting a first multi-core fiber including a first core and a second core to a second multi-core fiber including a third core and a fourth core in a state in which an axis of the first core and an axis of the third core are shifted from each other, and an axis of the second core and an axis of the fourth core are shifted from each other.
